(19) United States
(12) Patent Application Publication
(10) Pub. No.: US 2007/0054708 A1
(43) Pub. Date: Mar. 8, 2007

(54) Duplex-transmission lock-in device between a wireless microphone and a receiver

(76) Inventor: Te-Wei Kung, Chia-Yi City (TW)

Correspondence Address: Te-Wei KUNG, P.O. Box 90, Tainan City, 70499, TW

(21) Appl. No.: 11/220,531

(22) Filed: Sep. 8, 2005

(51) Int. Cl. H04M 1/00

(52) U.S. Cl. 455/575.2

(57) ABSTRACT

A duplex-transmission lock-in device between a wireless microphone and a receiver comprises respective infrared duplex transmission modules, each further comprising a receiving/transmitting unit, a plurality of resistors and a plurality of capacitors. Thereby, the infrared duplex transmission module within the microphone will transmit signals to the infrared duplex transmission module within the receiver for firstly checking the identity and the version of the microphone and then continuing to send signals to the receiver; this completes a lock-in process for a duplex communication of compatible data.

### FIELD OF THE INVENTION

The present invention relates to devises capable of attaining a duplex transmission and identity recognition between a wireless microphone and a receiver, whereby the microphone and the receiver can send compatible signals to and lock-in each other. More particularly, the duplex-transmission lock-in device between a wireless microphone and a receiver of the present invention utilizes an infrared transmission module composed of a receiving/transmitting unit and a plurality of resistors and capacitors.

### BACKGROUND OF THE INVENTION

Many occasions of gathering, such as classrooms and concerts, need transmission of audio signals from microphones to receivers. For a microphone with a signal wire, the microphone is connected to the receiver by the wire, and therefore checking the identity if not necessary. Then the signals from a microphone are pipelined to the associated receiver and are eventually broadcasted from a set of speakers. However, due to the limitation of length of the wire, the distance between the receiver and the microphone cannot be too long, and there will be problems of untangling the wires and being trapped by the wires. On the other hand, a wireless microphone/receiver system of the prior art needs a mechanism of frequency check for receiving signals from a microphone of such kind. This is usually done by approaching a microphone toward a receiver and pressing a button for frequency alignment. However, the conventional frequency-check process is unidirectional and therefore is prone to setting errors, resulting in a problem of compatibility. The inventor is therefore motivated to provide an improved design.

### SUMMARY OF THE INVENTION

The primary objective of the present invention is to provide a duplex-transmission lock-in device between a wireless microphone and a receiver capable of transmitting compatible data mutually and simultaneously, thereby achieving signal lock-in effectively.

The main features of the present invention are duplex infrared transmission modules installed in the receiver and the microphone, each having a receiving/transmitting unit, a plurality of resistors and a plurality of capacitors.

The various objects and advantages of the present invention will be more readily understood from the following detailed description when read in conjunction with the appended drawings.

### BRIEF DESCRIPTION OF THE DRAWINGS

FIG. 1 is a flow chart of the present invention.

FIG. 2 is the circuit layout of the microphone of the present invention.

FIG. 3 is the circuit layout of the receiver of the present invention.

### DETAILED DESCRIPTION OF THE INVENTION

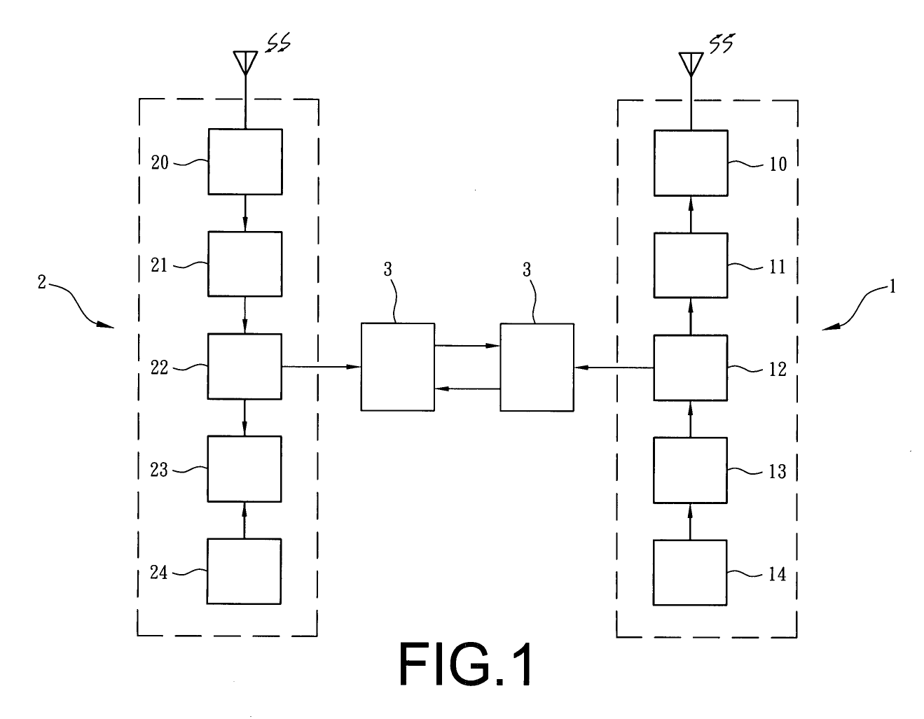

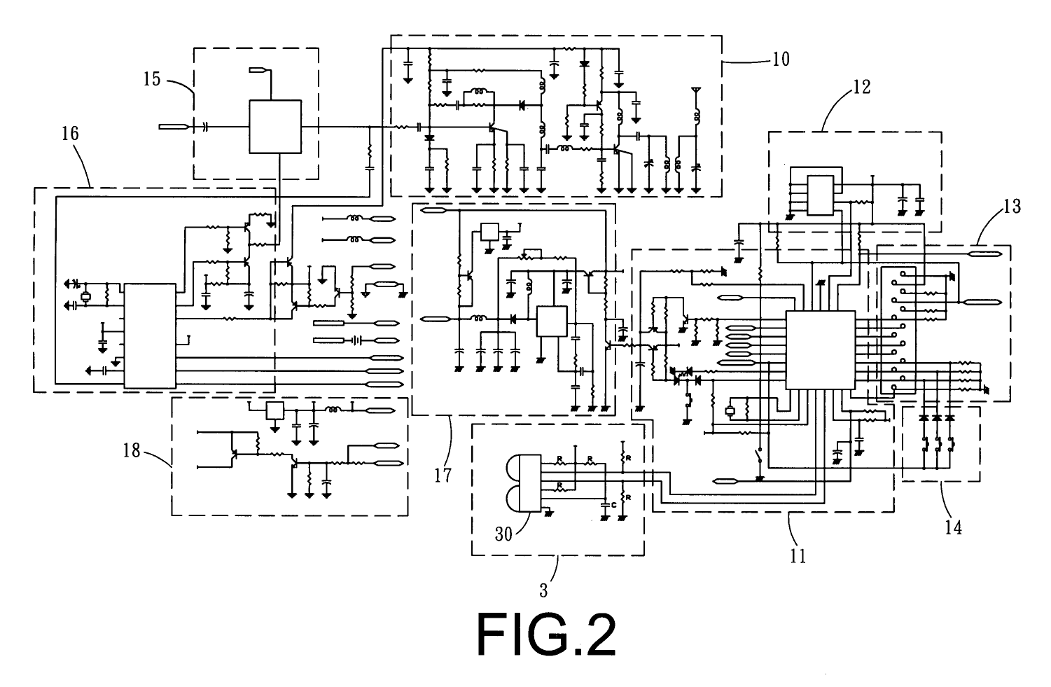

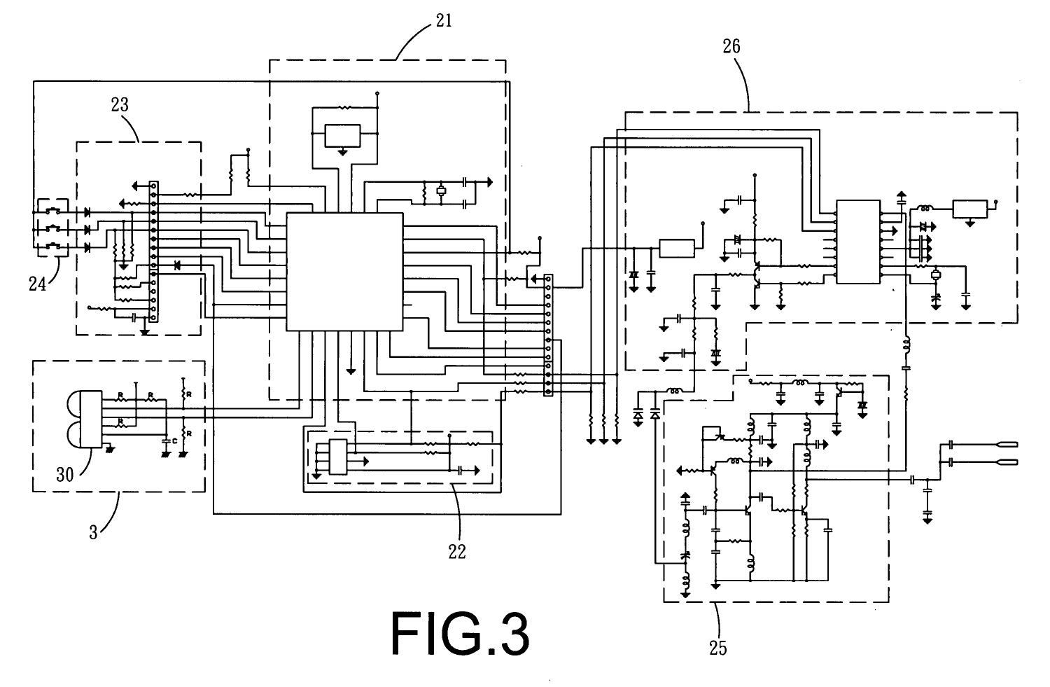

Referring to FIG. 1 to 3, a duplex-transmission lock-in device between a wireless microphone and a receiver according to the present invention comprises a microphone 1, a receiver 2 and respective infrared transmission modules 3. The microphone 1 further includes a radio emitting circuit 10, a circuit with a frequency-encoding chip 11, a circuit for processing frequency data 12, a circuit for displaying selected frequency 13, a circuit for selecting functions 14, a frequency oscillating circuit 15, a circuit for frequency phase lock-in 16, a power source circuit 17 and a voltage regulating circuit 18. The receiver 2 further includes a radio emitting circuit 10, a circuit with a frequency-encoding chip 21, a circuit for processing frequency data 22, a circuit for displaying selected frequency 23, a circuit for selecting functions 24, a frequency oscillating circuit 25 and a circuit for frequency phase lock-in 26. The infrared transmission modules 3 each comprise a receiving/transmitting unit 30, a plurality of resistors R and a plurality of capacitors C.

To use the preferred embodiment, a driving signal is transmitted to the receiver 2 from the circuit for processing frequency data 12 of the microphone 1, through the receiving/transmitting unit 30 of its infrared transmission module 3, as shown in FIGS. 1 to 3. The infrared transmission module 3 of the receiver 2 firstly checks the signal of identification and the version of data, and transmits a signal to the infrared transmission module 3 of the microphone 1, whereby the circuit with a frequency-encoding chip 11 of the microphone 1 will simultaneously lock the code of the signal and re-emit it by the radio emitting circuit 10 of the microphone 1 to the radio receiving circuit 20 of the receiver 1. Thereby, the circuit with a frequency-encoding chip 21 of the receiver 2 sends the signal to the circuit for processing frequency data 22 and then the circuit for displaying selected frequency 23 on which the frequency of the signal will be displayed. Therefore, a duplex communication for identifying the identity and the version of a signal between the microphone 1 and the receiver 2 can be attained.

1. The infrared transmission modules 3 for the microphone 1 and the receiver 2 are capable of doing automatic duplex data communication for searching and precise identification of the identity and the version of the data. They also allow simultaneous transmission of compatible data and precise luck-in.

2. The infrared transmission modules 3 for the microphone 1 and the receiver 2 substantially improve the traditionally unidirectional communication between the microphone 1 the receiver 2, attaining precise identification of the identity and the version of the data and preventing the problem of wrong settings.

3. The infrared transmission module 3 of the present invention is a cheap and energy-economical technology for wireless high-speed duplex data transmission.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A duplex-transmission lock-in device between a wireless microphone and a receiver, comprising:
a microphone;
a receiver; and
a pair of duplex infrared transmission modules respectively in said microphone and said receiver, each of said duplex infrared transmission modules having a receiving/transmitting unit, a plurality of resistors and a plurality of capacitors;
whereby said duplex infrared transmission module in said microphone will send a driving signal to said duplex infrared transmission module in said receiver for checking the identity and the version of said signal from said microphone, and said receiver will return a lock-in signal to said microphone for a recognition of the identity and the version of signal from said receiver, and whereby a signal lock-in will be done automatically.

2. The duplex-transmission lock-in device between a wireless microphone and a receiver of claim 1 wherein said receiver further comprises a radio emitting circuit, a circuit with a frequency-encoding chip, a circuit for processing frequency data, a circuit for displaying selected frequency, a circuit for selecting functions, a frequency oscillating circuit, a circuit for frequency phase lock-in, a power source circuit and voltage regulating circuit.

3. The duplex-transmission lock-in device between a wireless microphone and a receiver of claim 1 wherein said receiver further comprises a radio receiving circuit, a circuit with a frequency-encoding chip, a circuit for processing frequency data, a circuit for displaying selected frequency, a circuit for selecting functions, a frequency oscillating circuit and a circuit for frequency phase lock-in.
